(19) United States
(12) Patent Application Publication
(10) Pub. No.: US 2016/0057947 A1
(43) Pub. Date: Mar. 3, 2016

(54) DRIP EMITTER WITH COPPER AND PARTITION

(71) Applicant: Rain Bird Corporation, Azusa, CA (US)

(72) Inventors: Mark M. ENSWORTH, Orange, CA (US); Jae Yung Kim, Los Angeles, CA (US)

(21) Appl. No.: 14/475,435

(22) Filed: Sep. 2, 2014

(51) Int. Cl. A01G 25/02

(52) U.S. Cl. CPC A01G 25/023

(57) ABSTRACT

A drip emitter is provided for delivering irrigation water from a supply tube to an emitter outlet at a reduced and relatively constant flow rate. Water enters the emitter from the supply tube, flows through a tortuous path flow channel, and flows through an emitter outlet. Water then enters an outlet bath formed between the emitter and supply tube and flows out through a supply tube outlet. The outlet bath is defined by a boundary wall extending from the emitter base, and a partition separates the outlet bath into two sub-baths. A copper member is mounted to the emitter within one of the sub-baths in the outlet bath to inhibit plant root intrusion into the emitter outlet.

### FIELD OF THE INVENTION

The present invention relates to irrigation drip emitters, and more particularly, to subsurface irrigation drip emitters.

### BACKGROUND OF THE INVENTION

Drip irrigation emitters are generally known in the art for use in delivering irrigation water to a precise point at a predetermined and relatively low volume flow rate, thereby conserving water. Such irrigation devices typically comprise an emitter housing connected to a water supply tube through which irrigation water is supplied under pressure. The drip irrigation device taps a portion of the relatively high pressure irrigation water from the supply tube for flow through a typically long or small cross section flow path to achieve a desired pressure drop prior to discharge at a target trickle or drip flow rate. In a conventional system, a large number of the drip irrigation devices are mounted at selected positions along the length of the supply tube to deliver the irrigation water to a large number of specific points, such as directly to a plurality of individual plants.

Subsurface drip emitters provide numerous advantages over drip emitters located and installed above ground. First, they limit water loss due to runoff and evaporation and thereby provide significant savings in water consumption. Water may also be used more economically by directing it at precise locations of the root systems of plants or other desired subsurface locations.

Second, subsurface drip emitters provide convenience. They allow the user to irrigate the surrounding terrain at any time of day or night without restriction. For example, such emitters may be used to water park or school grounds at any desired time. Drip emitters located above ground, on the other hand, may be undesirable at parks and school grounds during daytime hours when children or other individuals are present.

Third, subsurface emitters are not easily vandalized, given their installation in a relatively inaccessible location, i.e., underground. Thus, use of such subsurface emitters results in reduced costs associated with replacing vandalized equipment and with monitoring for the occurrence of such vandalism. For instance, use of subsurface emitters may lessen the costs associated with maintenance of publicly accessible areas, such as parks, school grounds, and landscaping around commercial buildings and parking lots.

Fourth, the use of subsurface drip emitters can prevent the distribution of water to undesired terrain, such as roadways and walkways. More specifically, the use of subsurface drip emitters prevents undesirable “overspray.” In contrast, above-ground emitters often generate overspray that disturbs vehicles and/or pedestrians. The above-identified advantages are only illustrative; other advantages exist in connection with the use of subsurface drip emitters.

There is a need to prevent obstruction of an emitter outlet by plant roots intruding into the outlet. Some conventional methods of preventing root intrusion, and the accumulation of microscopic organisms, involve the use of herbicides, fungicides, algaecides, biocides, etc. For example, in some instances, herbicides have been released indiscriminately into the soil in an attempt to prevent plant root intrusion. Alternatively, herbicides have been mixed with the plastic materials from which the irrigation supply tube is made. Also, such chemicals have sometimes been mixed in dilute quantities with the irrigation water distributed by the tube.

These conventional methods are often not directed specifically to the emitters and emitter outlets and, therefore, may be of only limited effectiveness in preventing root intrusion. In addition, such conventional methods generally target plants and the environment indiscriminately and may have serious adverse effects on the health of plants, as well as the broader environment as a whole. Accordingly, there is a need for a mechanism that is more targeted and more environmentally friendly.

### BRIEF DESCRIPTION OF THE DRAWINGS

FIG. 1 is a top perspective view of a conventional assembled drip emitter;

FIG. 2 is a bottom perspective view of the drip emitter of FIG. 1;

FIG. 3 is a top exploded perspective view of the drip emitter of FIG. 1;

FIG. 4 is a bottom exploded perspective view of the drip emitter of FIG. 1;

FIG. 5 is a cross-sectional view of the drip emitter of FIG. 1 taken along line 5-5 of FIG. 1;

FIG. 6 is a top plan view of the upper housing of the drip emitter of FIG. 1;

FIG. 7 is a bottom plan view of the upper housing of the drip emitter of FIG. 1;

FIG. 8 is a bottom perspective view of the upper housing of the drip emitter of FIG. 1;

FIG. 9 is a top plan view of the lower housing of the drip emitter of FIG. 1;

FIG. 10 is a bottom perspective view of the lower housing of the drip emitter of FIG. 1;

FIG. 11 is a cross-sectional view of the drip emitter of FIG. 1 showing the emitter mounted in an irrigation supply tube;

FIG. 12 is a perspective view of the chimney and supply tube outlet of the mounted drip emitter of FIG. 11 as seen from outside the supply tube;

FIGS. 13-14 are perspective views of a first embodiment of an emitter housing portion of the present invention without the copper member;

FIG. 15 is a bottom plan view of the emitter housing portion of FIGS. 13-14 with the copper member;

FIG. 16 is a top plan view of the emitter housing portion of FIGS. 13-14;

FIG. 17 is a side elevational view of the emitter housing portion of FIGS. 13-14;

FIGS. 18-19 are perspective views of a second embodiment of an emitter housing portion of the present invention with the copper member;

FIG. 20 is a bottom plan view of the emitter housing portion of FIGS. 18-19;

FIG. 21 is a top plan view of the emitter housing portion of FIGS. 18-19; and

FIG. 22 is a side elevational view of the emitter housing portion of FIGS. 18-19.

### DESCRIPTION OF THE PREFERRED EMBODIMENTS

The present disclosure is directed generally to drip emitters having housing portions 200 and 300 that resist intrusion of plant roots, dirt, and other material into the out let of the emitter. Further, the housing portions 200 and 300 can generally be used with drip emitters shown and described in U.S. application Ser. Nos. 11/359,181; 11/394,755; and 12/436,394; all of which are assigned to the applicant and are incorporated by reference herein in their entirety. The housing portions 200 and 300 described herein work effectively with a copper member 64 disposed at the housing portion 200 and 300 to inhibit root intrusion into the emitters, as described in more detail below.

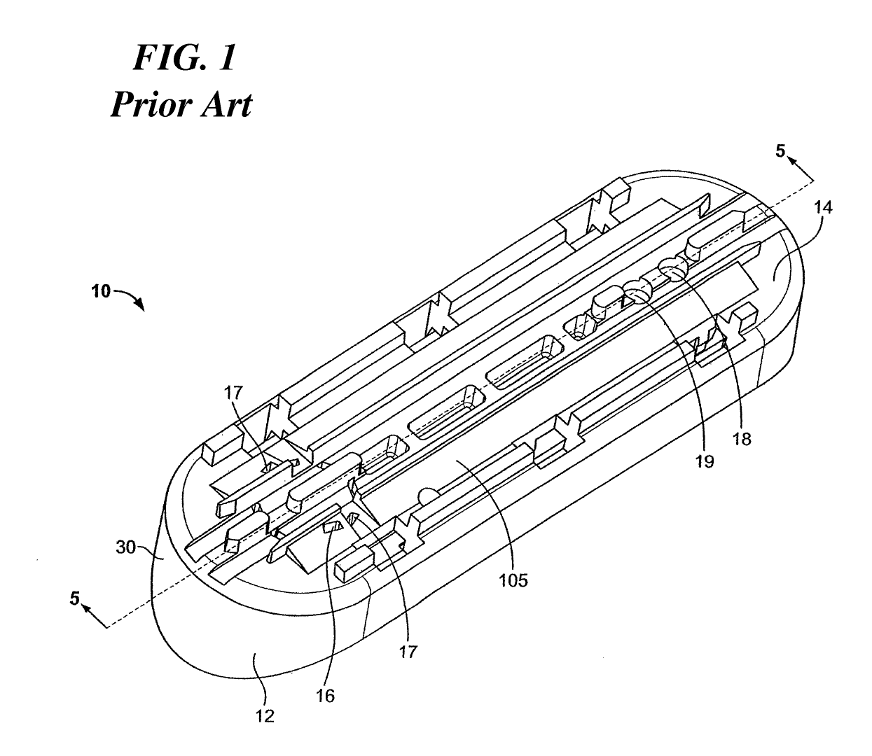

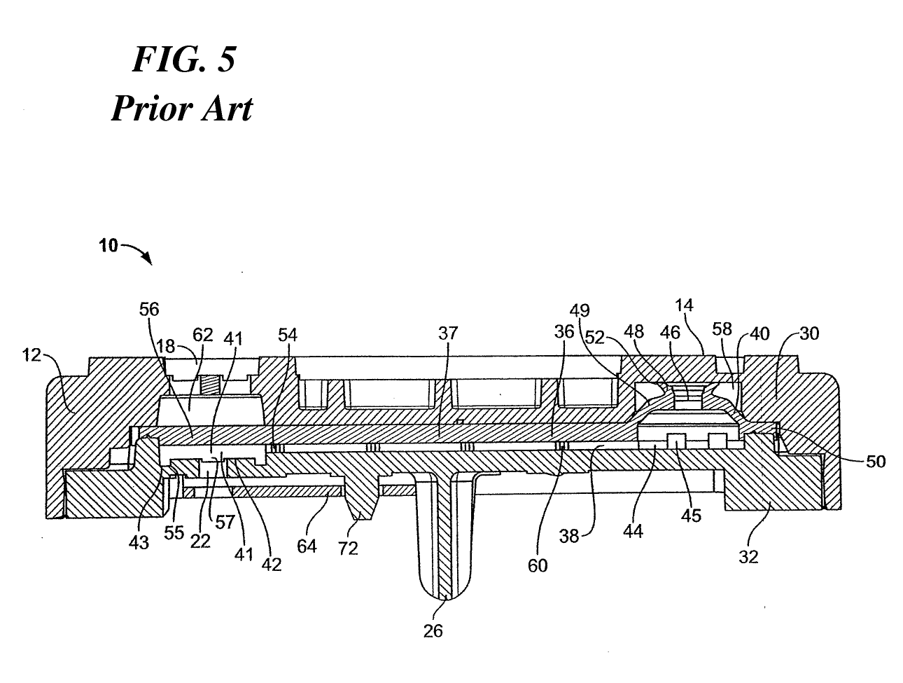

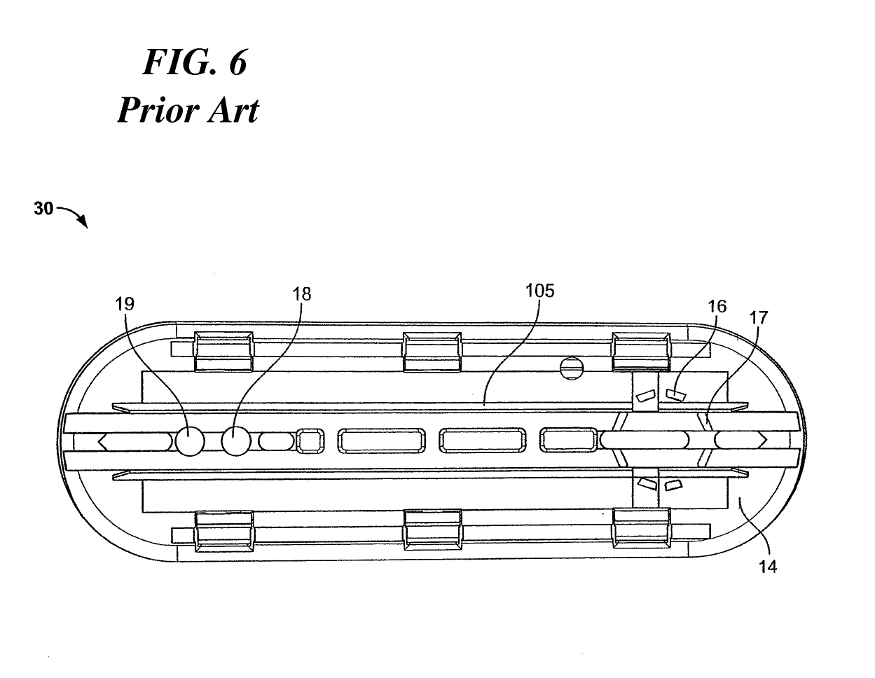

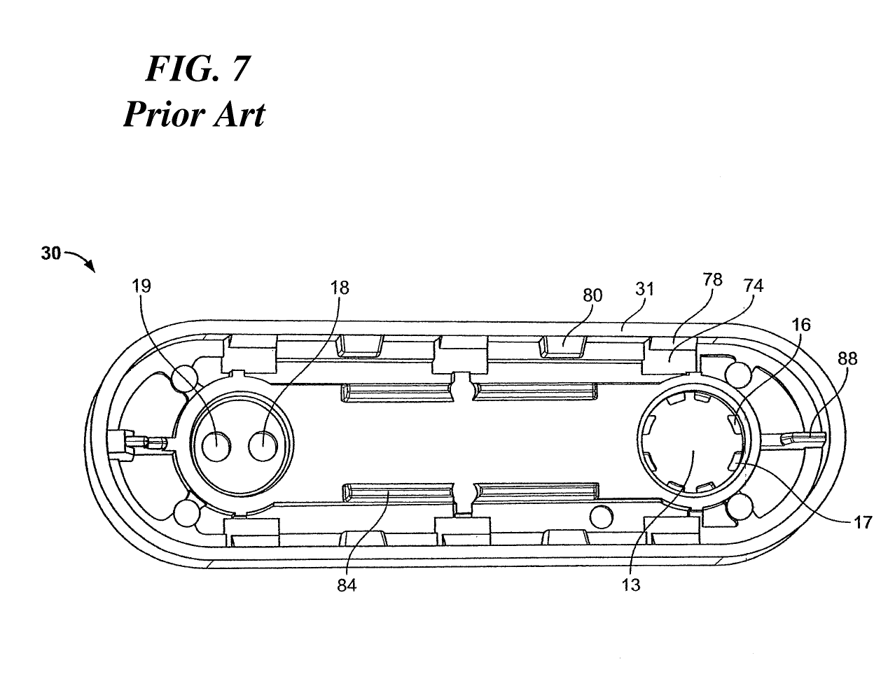

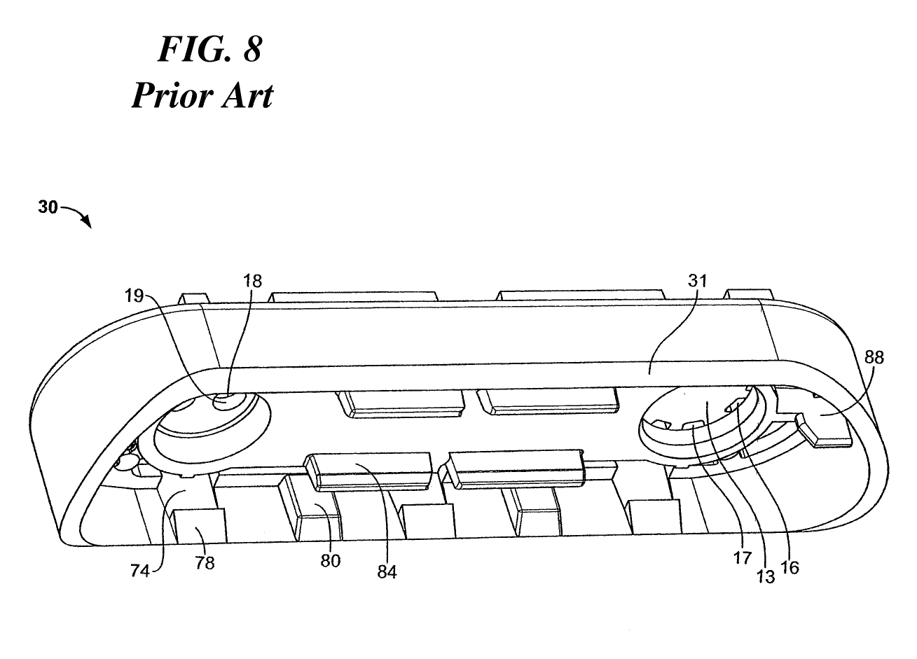

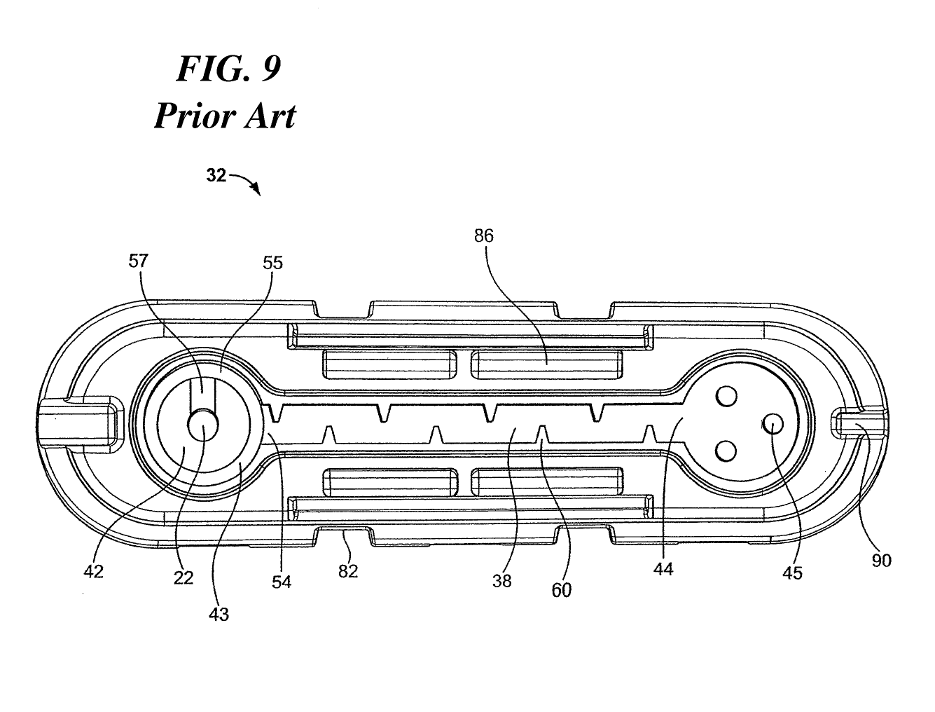

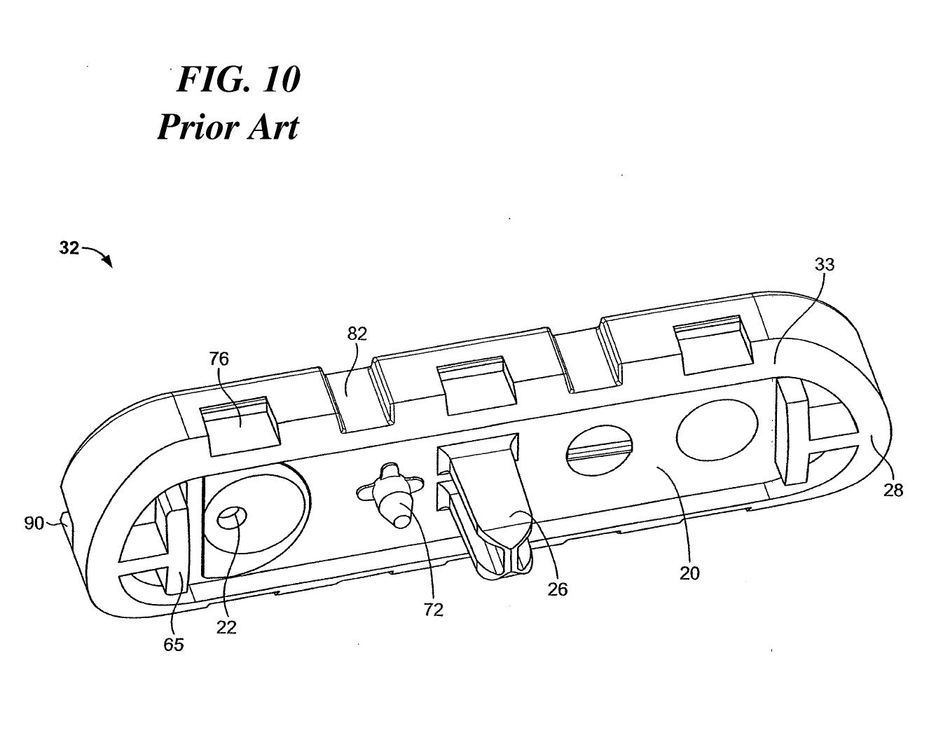

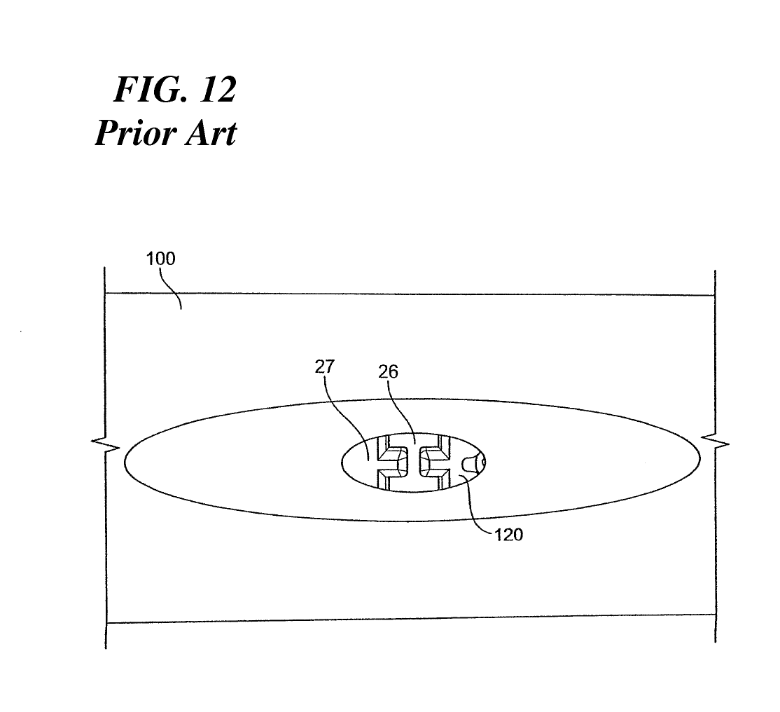

FIGS. 1-12 show a conventional drip emitter 10, shown and described in U.S. application Ser. No. 12/436,394, which can incorporate the housing portion 200. This emitter 10 is reproduced herein for illustrative purposes only, and other emitters may also be used. The following description regarding emitter 10 provides a general understanding of its structure and operation, but a complete description is included in U.S. application Ser. No. 12/436,394. The reference numerals corresponding to the components of emitter 10 described in U.S. application Ser. No. 12/436,394 are included in FIGS. 1-12.

The emitter 10 is provided for delivering irrigation water from a water supply conduit, such as an irrigation supply tube, at a low volume, substantially trickle, or drip flow rate. The emitter 10 operates generally through the use of a tortuous path flow channel 38 that causes a pressure reduction between the irrigation tube and an emitter outlet 22. The emitter 10 includes a first inlet 16 for tapping a portion of the water flow from the irrigation tube, and, when the water pressure is above a predetermined minimum level, directing the flow to and through the tortuous path flow channel 38 for subsequent discharge to a desired location. In this form, the emitter 10 also includes a second inlet 18 for maintaining relatively constant output water flow by compensating for fluctuations in water pressure in the irrigation tube.

The emitter 10 comprises a compact housing 12 made of a sturdy and non-corrosive material. As shown in FIG. 1, the top surface 14 of the emitter 10 defines two sets of inlets 16 and 18, each including one or more openings extending through the top surface 14. The inlets are exposed to the irrigation water flowing through the inside of the irrigation tube.

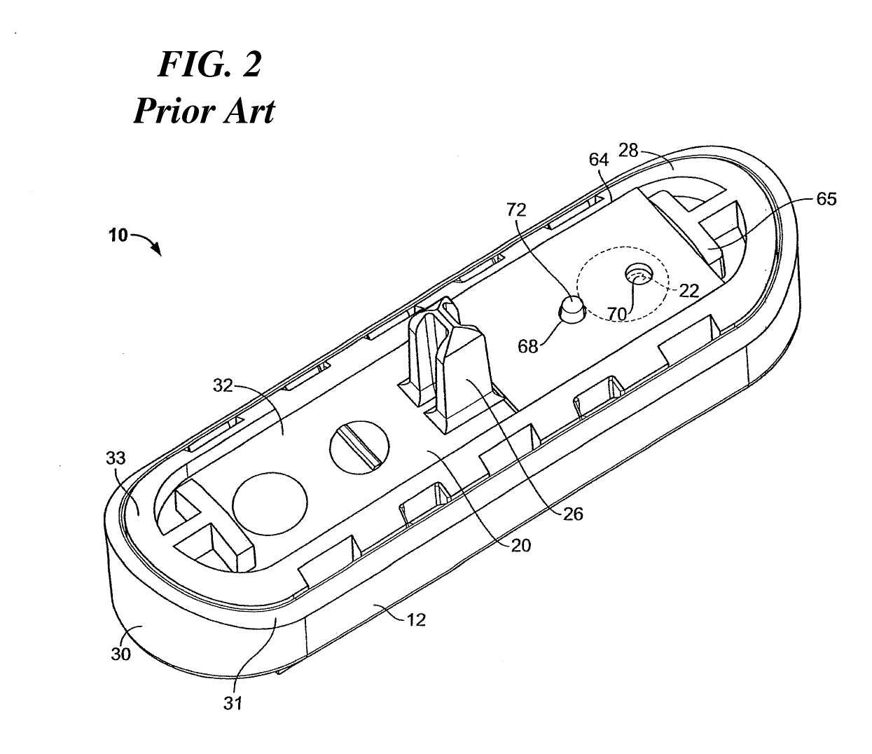

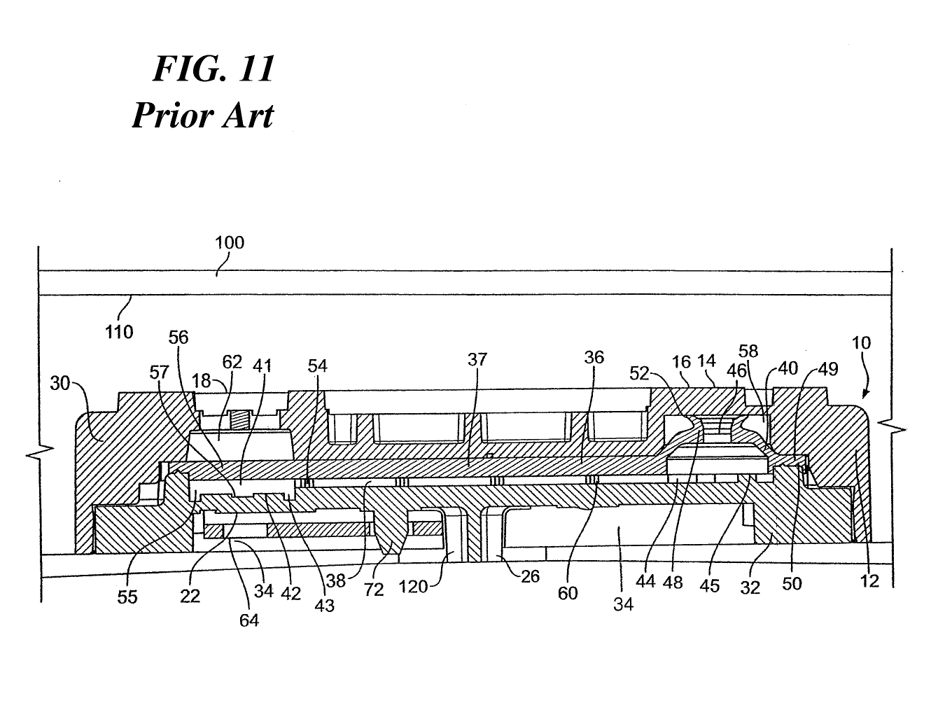

FIG. 2 shows the base 20 of the emitter 10 with an emitter outlet 22, composed of at least one opening, extending through the base 20, and with a raised rim 28 extending about the perimeter of the base 20. During assembly, in this form, a number of emitters 10 are mounted to the inside surface 110, or wall 110, of an irrigation tube 100 at predetermined spaced intervals with each emitter 10 oriented such that the raised rim 28 of each is pressed into sealing engagement with the inside surface 110 of the irrigation tube 100, as shown in FIG. 11. Thus, the raised rim 28 of each emitter 10 is used to mount the emitter 10 to the inside surface 110 of the irrigation tube 100 by acting as an attachment zone. Further, when the base 20 of each emitter 10 is mounted and the raised rim 28 of each emitter 10 is bonded into sealing engagement with the inside surface 110 of the irrigation tube 100, a gap is formed between the remainder of the base 20 (inside the perimeter) and the inside surface 110 of the tube 100. The gap resulting from the mounting of the emitter base 20 to the tube wall 110 forms an outlet bath 34 for the discharge of water from the emitter 10, as described below.

In this form, as shown in FIG. 2, the base 20 of the emitter 10 also preferably includes an elongated protrusion, or chimney, 26, which, in the preferred embodiment, has an I-shaped cross-section. The chimney 26 is adapted to push outwardly against the tube wall 110 during assembly, thereby forming an area of the irrigation tube 100 that bulges outward. The outside of the tube 100 then passes under a cutting tool that cuts the projecting tube portion and projecting end of the chimney 26 to form a supply tube outlet 120 that, in contrast to the emitter outlet 22, extends through the wall 110 of the irrigation tube 100. After cutting, as shown in FIG. 11, the remaining uncut chimney portion extends between the base 20 of the emitter 10 and through the tube outlet 120, allowing water to flow to terrain outside the tube 100. More specifically, water exiting the emitter 10 through the emitter outlet 22 flows into outlet bath 34 and trickles out to the terrain to be irrigated through the elongated channels formed by the I-shaped cross-section of the remaining chimney portion and through the supply tube outlet 120. The outlet bath 34 acts as an outlet conduit between the emitter outlet 22 and the supply tube outlet 120 when the emitter 10 is mounted inside the tube 100.

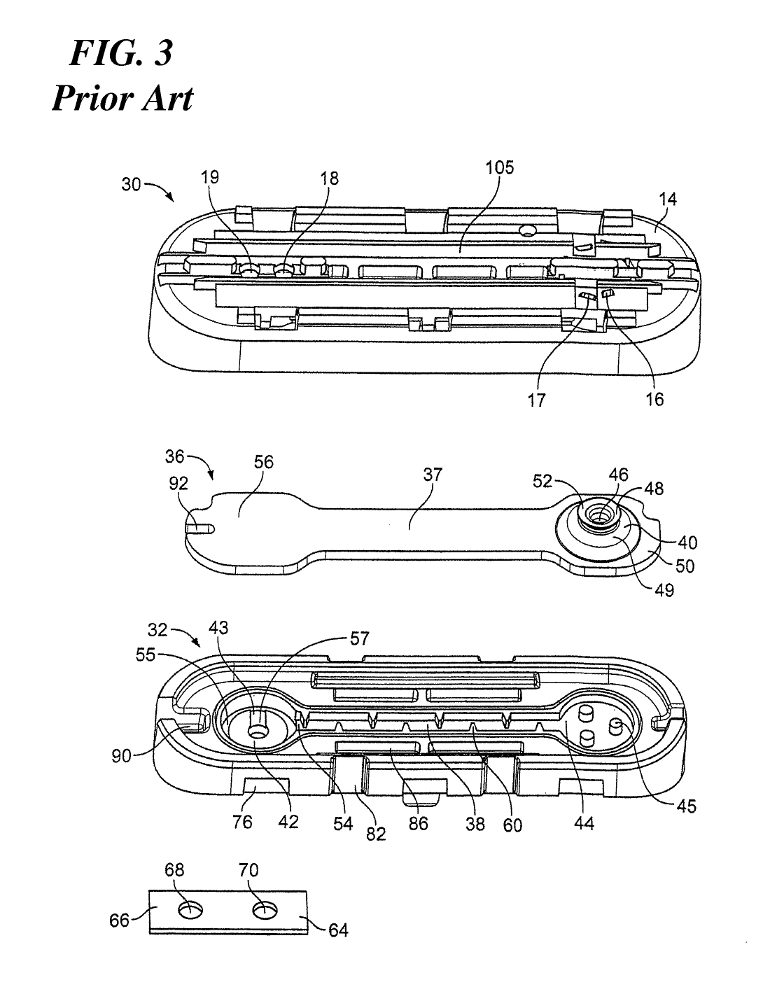

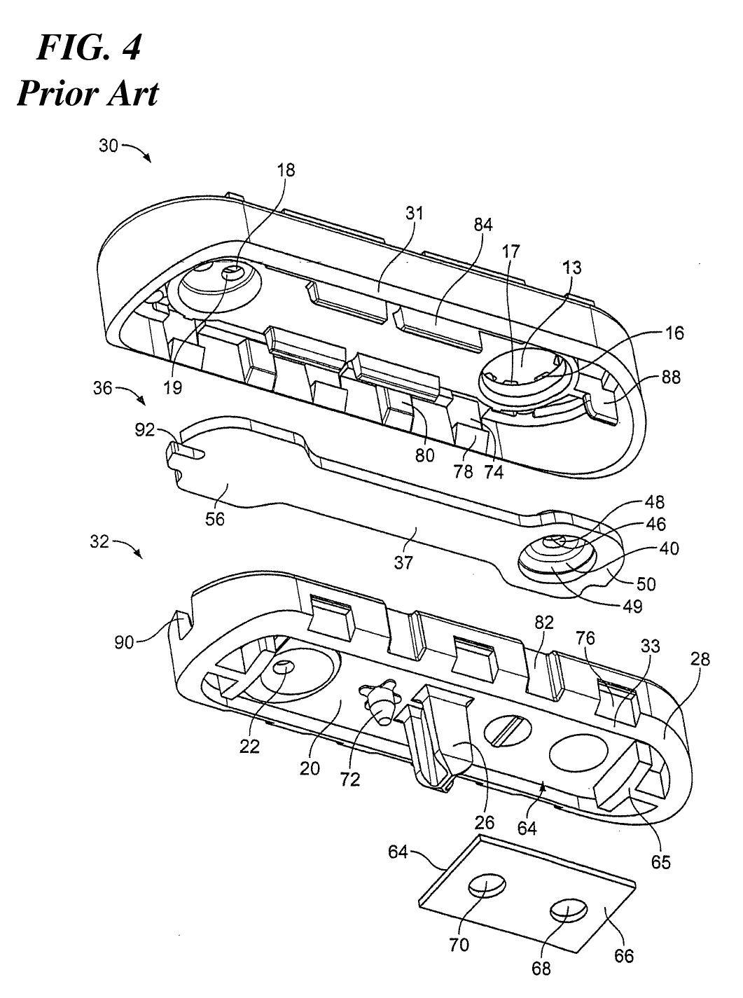

As shown in FIGS. 3 and 4, the emitter 10 generally includes four components: an upper housing 30, a lower housing 32, a diaphragm 36, and a copper member 64. The upper housing 30 and lower housing 32 may be conveniently and economically formed from assembled plastic molded housing components. Although the illustrative form uses two separate housing pieces assembled together, one integral housing piece (having a lower housing portion and an upper housing portion) may also be used. The upper housing 30 is adapted for assembly with the lower housing 32 to form a substantially enclosed housing interior, which encloses the diaphragm 36. A copper member 64 is preferably mounted to the underside of the lower housing 32.

The upper housing 30 includes the first inlet 16 and the second inlet 18, each inlet including one or more openings extending through a portion of the upper housing 30. The lower housing 32 includes the emitter outlet 22, which extends through a portion of the lower housing 32. Further, the lower housing 32 preferably includes the chimney 26, which projects away from the upper housing 30. The lower housing 32 also includes raised rim 28 located about the perimeter of the lower housing 32, the raised rim 28 defining outlet bath 34 when mounted to the inside surface 110 of the irrigation tube 100.

The lower housing 32 includes an inlet end 44, the tortuous path flow channel 38, and the water metering surface 42, which are formed on the interior side of the lower housing 32. Water flows in the flow path defined by interior side of the lower housing 32 and the overlaying diaphragm 36. More specifically, water enters the inlet end 44, flows through the tortuous path flow channel 38, and flows through the water metering surface 42 to the emitter outlet 22.

The tortuous path flow channel 38 (or pressure-reducing flow channel) preferably includes a number of alternating, flow diverting ribs 60 (or baffles) projecting partially into the flow channel 38 and causing frequent, regular, and repeated directional changes in water flow. Accordingly, the water flow takes on a back and forth zigzag pattern. The tortuous path flow channel 38 causes a relatively significant reduction in water pressure. In contrast, the water metering surface 42 is responsive to more subtle fluctuations in water pressure in the irrigation tube 100.

In the illustrative form, a portion of the diaphragm defines a valve 40. The valve 40 is preferably a check valve, or other one-way directional valve, and is positioned between the first inlet 16 and the inlet end 44 of the tortuous path flow channel 38. The valve 40 is open and permits water flow between the first inlet 16 and the emitter outlet 22 when the supply water pressure is above a predetermined minimum level, such as 5 psi. The valve 40, however, closes off the flow path through the emitter 10 when the water pressure falls below the predetermined minimum level, as may occur when an irrigation cycle is completed. Closing the flow path through the emitter 10 prevents the water in the irrigation supply tube 100 from slowly draining to the outside through the emitter 10 and prevents backflow from entering the tube 100 from the emitter 10. Closing the flow path also prevents back siphoning into the emitter 10, i.e., closing the flow path prevents dirt and debris from outside terrain from entering and clogging the emitter 10.

Water flowing through the irrigation tube 100 enters the emitter 10 through the first inlet 16. It then enters a first chamber 58 defined, at least in part, by a portion of the upper housing 30, the boss 48, and the snap button 49. The boss 48 initially is in sealing engagement with a portion of the upper housing 30 to block the flow channel through the diaphragm hole 46. If the pressure of water flowing into the first chamber 58 and impacting the snap button 49 is below a predetermined minimum level, the boss 48 remains in sealing engagement with the upper housing 30, which, in effect, acts as a valve seat. If, however, the pressure of water flowing into the first chamber 58 and impacting the snap button 49 is above the minimum level, the upper end 52 of the boss 48 disengages from the upper housing 30, thereby opening the flow channel through the diaphragm hole 46.

Water then flows through the hole 46 in the diaphragm 36 to the inlet end 44 of the tortuous path flow channel 38. The water then experiences multiple directional changes as it is constantly redirected by the flow-diverting ribs 60 defining the tortuous path flow. This repeated redirection significantly reduces the water pressure and water flow by the time the water reaches the outlet end 54 of the tortuous path flow channel 38. The water then flows through the water metering chamber 41. Next, the water proceeds through the emitter outlet 22, though the outlet bath 34 (defined by the region between the base 20 and the inside surface 110 of the irrigation tube 100), and out through the supply tube outlet 120 (an opening defined by the tube wall 110 and the I-shaped cross-section of the chimney 26). The water exits through the supply tube outlet 120 to the terrain and vegetation outside the tube 100. Once an irrigation cycle is complete, or if the water pressure in the irrigation tube 100 otherwise falls below the predetermined minimum level, the boss 48 in the diaphragm 36 returns to it relaxed state, closing valve 40 and creating a seal to prevent drainage and back siphoning through the emitter 10.

The water metering surface 42 includes a groove 43 for regulating fluid flow. As shown in FIGS. 3, 5, and 9, the groove 43 has a recessed annular portion 55 that extends about the circumference of the water metering surface 42 and a recessed radial portion 57 connecting a point along the annular portion 55 to the emitter outlet 22. When the diaphragm 36 is fully distended by relatively high pressure, it is deflected into and presses against the water metering surface 42. The groove 43 provides a flow path along the depressed annular portion 55 to the depressed radial portion 57 and out through the emitter outlet 22. The groove 43 allows output flow even at relatively high water pressure, such that deflection of the diaphragm 36 does not completely obstruct fluid flow through the water metering chamber 41. Thus, the diaphragm 36, water metering chamber 41, water metering surface 42, and groove 43 act as a pressure-dependent mechanism to offset differences in water pressure in the irrigation tube 100 to maintain the flow rate through the emitter 10 at a relatively constant level.

As shown in FIGS. 2-5 and 11, a copper member 64 is preferably used at the emitter outlet 22 to prevent plant root intrusion. Use of copper is effective because, although copper is a required nutrient for plant growth, excessive amounts of copper inhibit root cell elongation. When a plant root comes into contact with copper, the surface of the root is damaged, the root hairs die off, and the overall growth of the root is stunted. The copper, however, does not cause any serious damage to the plant itself. Because the copper remains in the plant's root tissue, it only inhibits growth of the roots in close proximity to the copper and does not affect the overall health of the plant.

The interaction between copper and plant roots is used to protect the emitter 10 from root intrusion and obstruction of the emitter outlet 22. A copper member 64 is located in front of the emitter outlet 22 in order to inhibit root growth into the outlet 22. The amount of copper that is taken up by plant roots is infinitesimal, and therefore, the life of the copper member 64 is extremely long.

One cost effective form of a copper member 64, shown in FIGS. 3 and 4, is a thin rectangular copper plate 66 having two holes 68 and 70 therethrough. The copper plate may be composed of copper entirely or in part, but preferable includes a copper outer surface. The copper plate 66 is preferably compression fitted to the base 20 of the emitter 10, such that the base 20 holds the copper plate 66 in place. The first hole 68 also is preferably dimensioned to receive a locator peg 72 protruding from the base 20 of the emitter 10 to provide an additional mounting for the plate 66. The two holes 68 and 70 on the plate 66 are spaced such that, when the first hole 68 is positioned over the locator peg 72, the second hole 70 is situated over the emitter outlet 22. The copper plate 66 may be mounted to the base 20 of the emitter 10 in various ways, i.e., the copper plate 66 can be heat staked, glued, co-molded, or otherwise mounted to the base 20. Alternatively, part or all of the base 20 may be flashed with a thin protective copper layer about the emitter outlet 22.

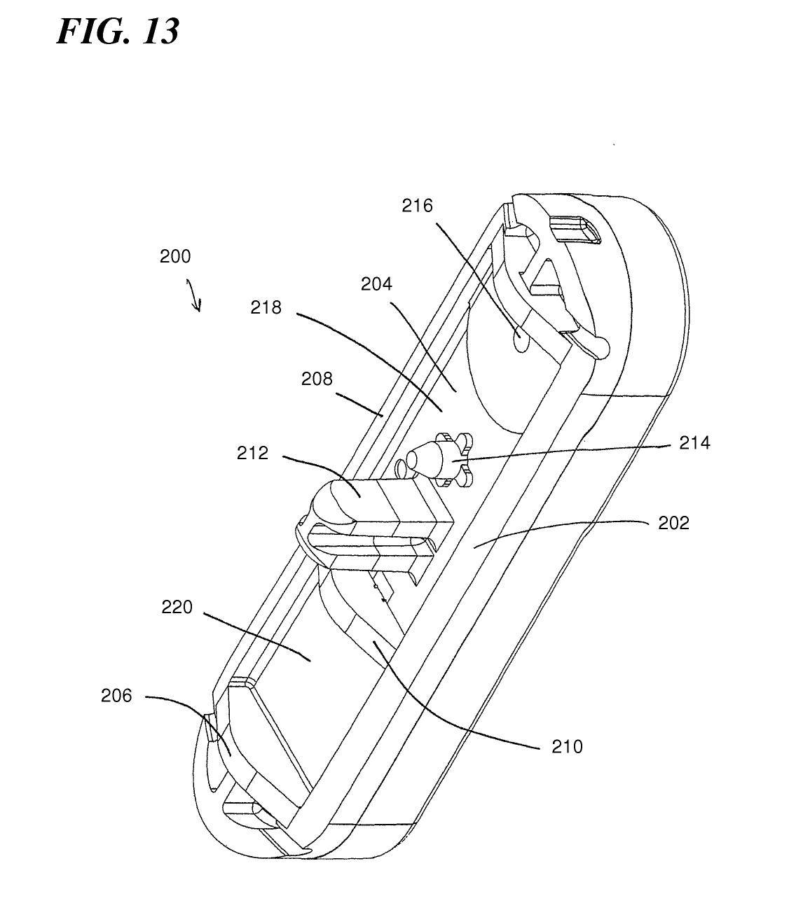

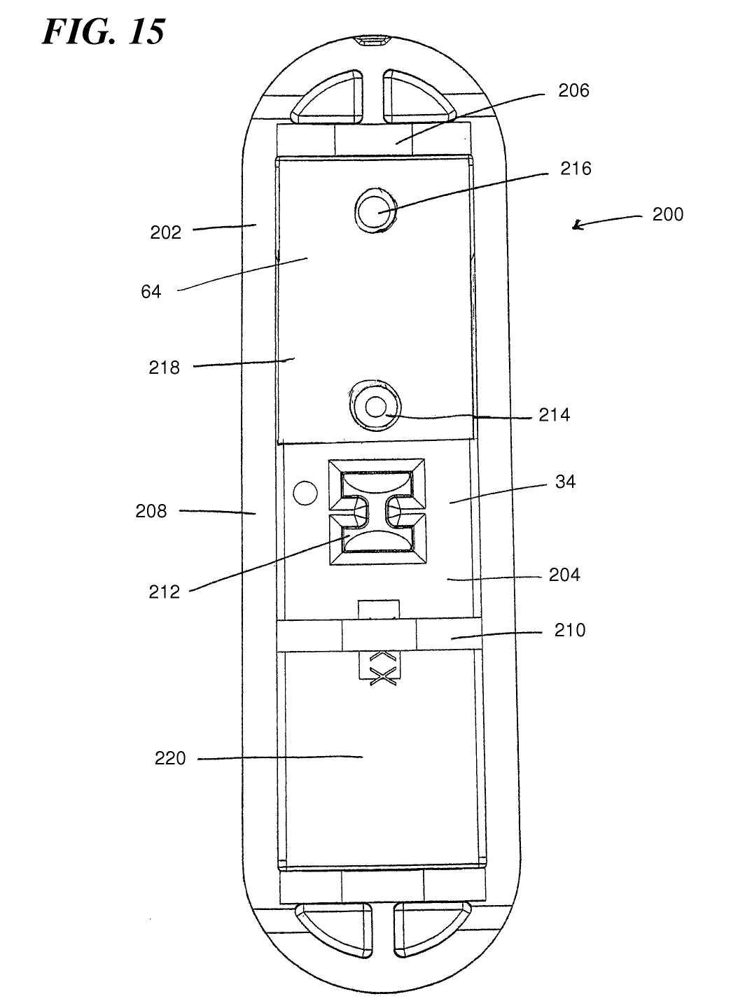

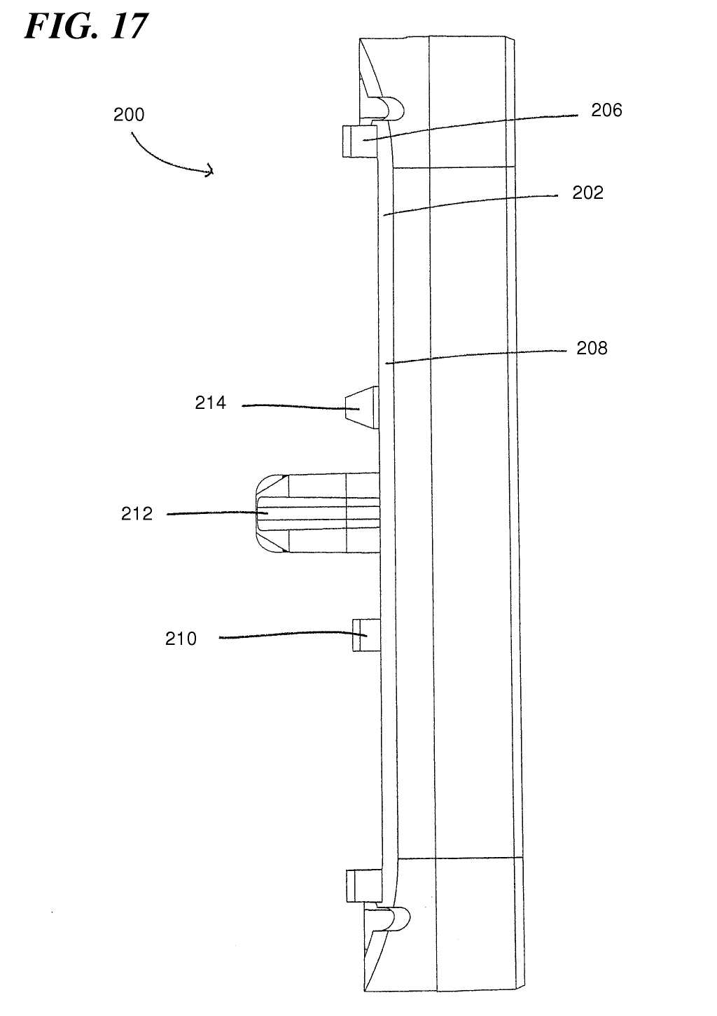

The present disclosure shows a housing portion 200 that further inhibits the intrusion of plant roots, dirt, and other material into the emitter. FIGS. 13-17 show a first embodiment of a housing portion 200 forming part of an emitter and embodying features of the present invention. As described further below, the housing portion 200 includes a boundary wall 202 extending outwardly from the base 204 of the emitter. More specifically, this housing portion 200 includes two curved mounting end walls 206 defining ends of the outlet bath 34, two side walls 208 defining sides of the outlet bath 34 and contoured to engage the inside of the supply tube, and a partition 210 that reduces the effective volume of the outlet bath 34 when the emitter is inserted in the supply tube 100. In turn, this reduction increases the proximity and effectiveness of the copper member 64 with respect to roots potentially intruding into the outlet bath 34.

As shown in FIGS. 13-17, the housing portion 200 includes an exterior side for mounting to the inside of the supply tube 100 and an interior side facing the interior of the supply tube 100. The exterior side preferably includes the two end walls 206, the two side walls 208, the partition 210, a chimney or post 212, a locator post 214 for mounting a copper member 64, and the emitter outlet 216. The two end walls 206 and the two sidewalls 208 preferably have a curvature corresponding generally to the curvature of the inside of the supply tube 100. The chimney 212 is preferably I-shaped in cross-section, creates a bulge in the tube 100 during insertion, and forms the supply tube outlet 120 when a portion of the chimney 212 is cut. As described above, the copper member 64 preferably includes two apertures, one sized for receiving the locator post 214 and the other sized for extending over the emitter outlet 216.

The end walls 206 and side walls 208 are sized and oriented to provide the emitter with a strong and secure bond to the inside of the supply tube 100. During the emitter insertion process, the end walls 206 and side walls 208 are bonded to the inside of the supply tube 100. As can be seen in FIG. 13, the partition 210 is preferably parallel to the end walls 206 and has a curvature that generally corresponds to the curvature of the inside of the supply tube 100. In one form, the end walls 206 and partition 210 preferably have the same height (the distance they extend away from the emitter base 204) such that the partition 210 may also be bonded to the inside of the supply tube 100.

In another form, the height of the partition 210 (the distance it extends away from the emitter base 204) may be slightly less than the heights of the mounting end walls 206. The height may be less so as to ensure that the partition 210 does not interfere with the bonding of the end walls 206 and the side walls 208 to the inside of the supply tube 100 during the emitter insertion process due to manufacturing variations. In other words, the partition 210 may have a height slightly less than the end walls 206 so as to avoid interfering with or weakening the bonding of the end walls 206 and side walls 208 to the supply tube 100. However, the height of the partition 210 is still sufficiently great so that the partition 210 functions as a physical barrier to plant roots and other material, as addressed further below.

Generally, during insertion of the emitter, the chimney 212 creates a bulge that is cut to form the supply tube outlet 120. This bulge may be formed slightly differently for each emitter, so it is desirable to reduce the height of the partition 210 to avoid weakening the bond of the emitter the supply tube 100. Further, the emitter and supply tube 100 define a relatively large outlet bath 34 that is centered about the chimney 212 and extends longitudinally in opposite directions from the chimney 212. One portion of the outlet bath 34 is disposed generally between the emitter outlet 216 and the supply tube outlet 120 while a second portion of the outlet bath 34 is disposed on the other side of the chimney 212 from the emitter outlet 216.

The partition 210 is a physical barrier that reduces the effective volume of the outlet bath 34 in which roots may potentially intrude. It is disposed on opposite side of the chimney 212 from the emitter outlet 216. In effect, the partition 210 creates two discrete sub-baths 218 and 220 that are separated by the partition 210. Each sub-bath 218 and 220 is defined generally by an end wall 206, portions of the two side walls 208, and the partition 210. These sub-baths 218 and 220 may be completely enclosed or may be substantially enclosed if the partition 210 does not extend completely to the inside surface of the supply tube 100. One sub-bath 218 is in the flow path of fluid flowing from the emitter outlet 216 and then through the supply tube outlet 120, while the other sub-bath 220 is outside of this flow path. As can be seen from FIG. 11, the first sub-bath 218 would include the portion of the outlet bath 34 with the emitter outlet 22, chimney 26, and supply tube outlet 120, while the partition (not shown) would generally block off the remainder of the outlet bath 34.

Without a partition 210, roots may potentially intrude through the supply tube outlet 120 and into the outlet bath 34 in a direction away from the copper member 64. These roots may also bring soil, vegetation, and other elements along with them into the far end of the outlet bath 34. These roots and other materials may over the long term cause a deterioration or breakdown of the emitter itself.

Further, it has been found that dirt tends to accumulate in the portion of the outlet bath 34 that is on the opposite side of the chimney 212 from the emitter outlet 216. The far end of the outlet bath 34 is not in the flow path such that dirt tends to accumulate in this “dead zone.” In contrast, the portion of the outlet bath 34 between the emitter outlet 216 and supply tube outlet 120 is in the flow path such that fluid circulates through it during operation of the emitter. In addition, during operation, dirt and other material may be sucked back (such as by back siphoning) into the far end of the outlet bath 34 through the supply tube outlet 120, and this accumulation will not be flushed from the emitter because it is outside the flow path. The partition 210 has been found to be effective in minimizing the accumulation of dirt in this “dead zone.”

By including the partition 210, the intrusion of plant roots and dirt through the supply tube outlet 120 is discouraged. Plant roots and other material are physically blocked by the partition 210 from intruding through the supply tube outlet 120 and into the far end of the outlet bath 34 away from the copper member 64. In turn, plant roots, soil, vegetation, and other elements are prevented from infiltrating and accumulating at this far end, potentially causing long term deterioration and failure of the emitter.

Without the partition 210, the copper member 64 may have to be extended along the entire length of the outlet bath 34 to prevent intrusion into the outlet bath 34, which is more costly than using copper for only the relevant portion. In addition, manufacturing limitations make placing the copper member 64 at the chimney 212 and supply tube outlet 120 costly and difficult. Copper ions from the copper member 64 discourage any plant roots near the supply tube outlet 120 from thickening sufficiently to block flow through the supply tube outlet 120. Thus, a copper member 64 disposed between the emitter outlet 216 and chimney 212 is desirable with the remainder of the outlet bath 34 physically blocked by the partition 210.

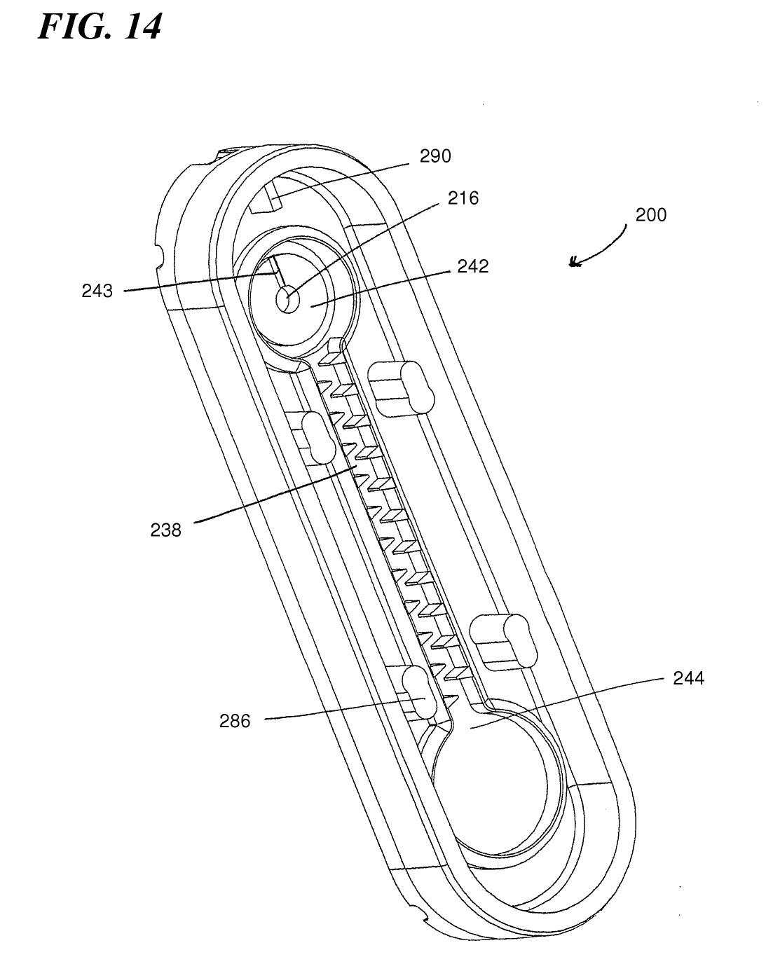

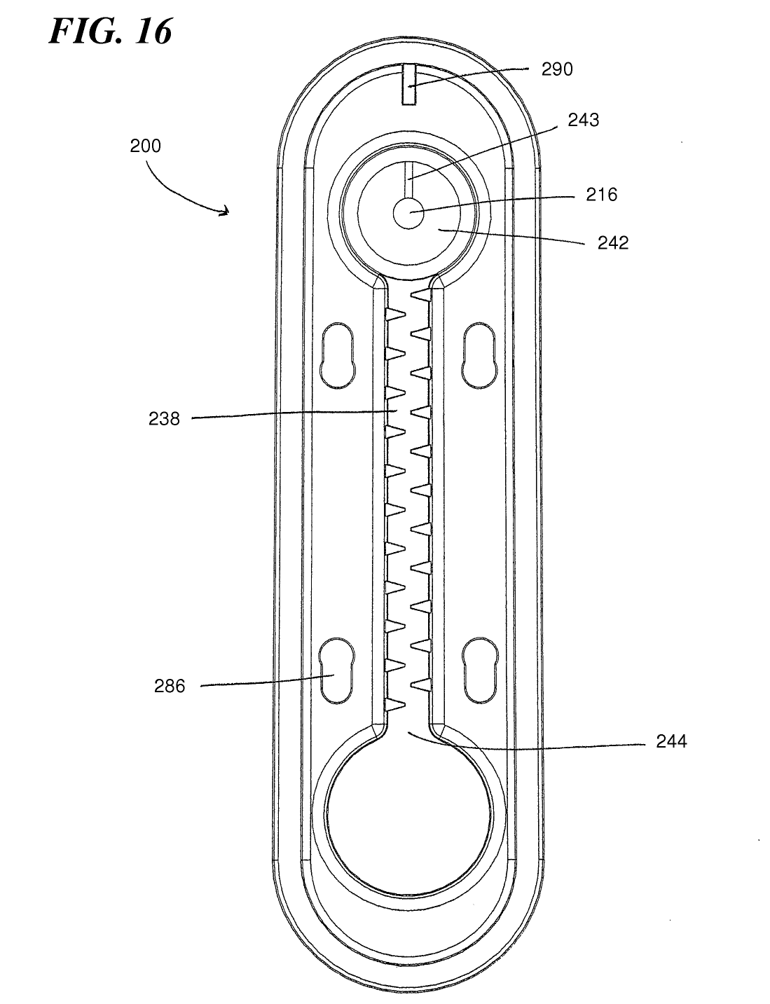

Further, as shown in FIGS. 14 and 16, the interior side of the housing portion 200 is similar to that described above. It includes an inlet end 244, a pressure-reducing flow channel 238, and a water metering surface 242 with a groove 243 formed therein. Water flows in the flow path defined by interior side of the housing portion 200 and an overlaying diaphragm 36. More specifically, water enters the inlet end 244, flows through the pressure-reducing flow channel 238, and flows past the water metering surface 242 to the emitter outlet 216. In this form, the interior side also preferably includes posts 286 for insertion of the sides of the diaphragm 36 therebetween to limit movement of the diaphragm 36 in the transverse direction and to align the diaphragm 36 within the housing. The interior side also preferably includes a stop 290 at one longitudinal end for reception of a slot in the diaphragm 36 to limit longitudinal movement of the diaphragm 36.

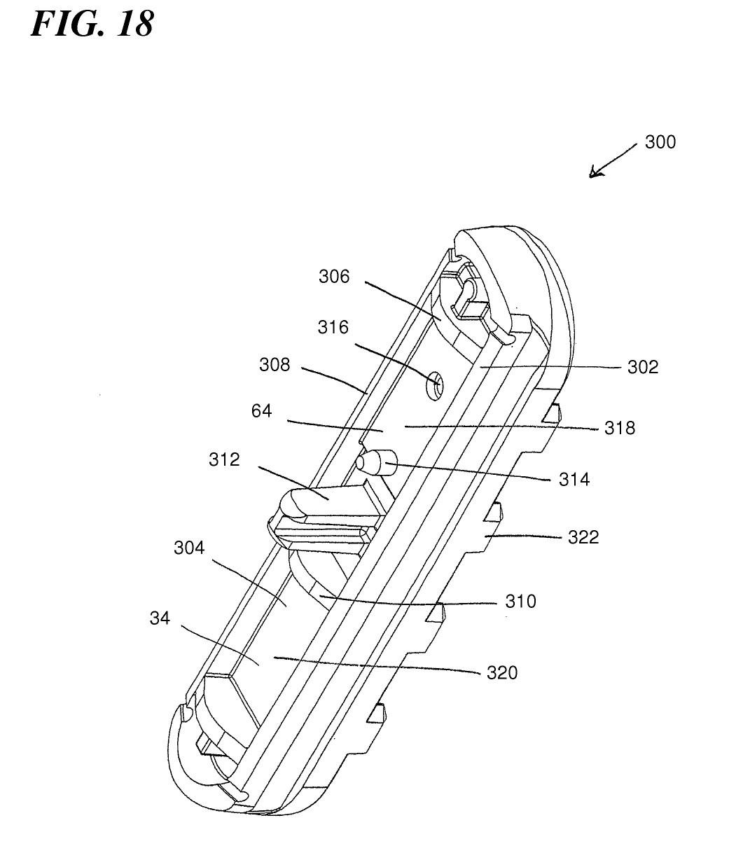

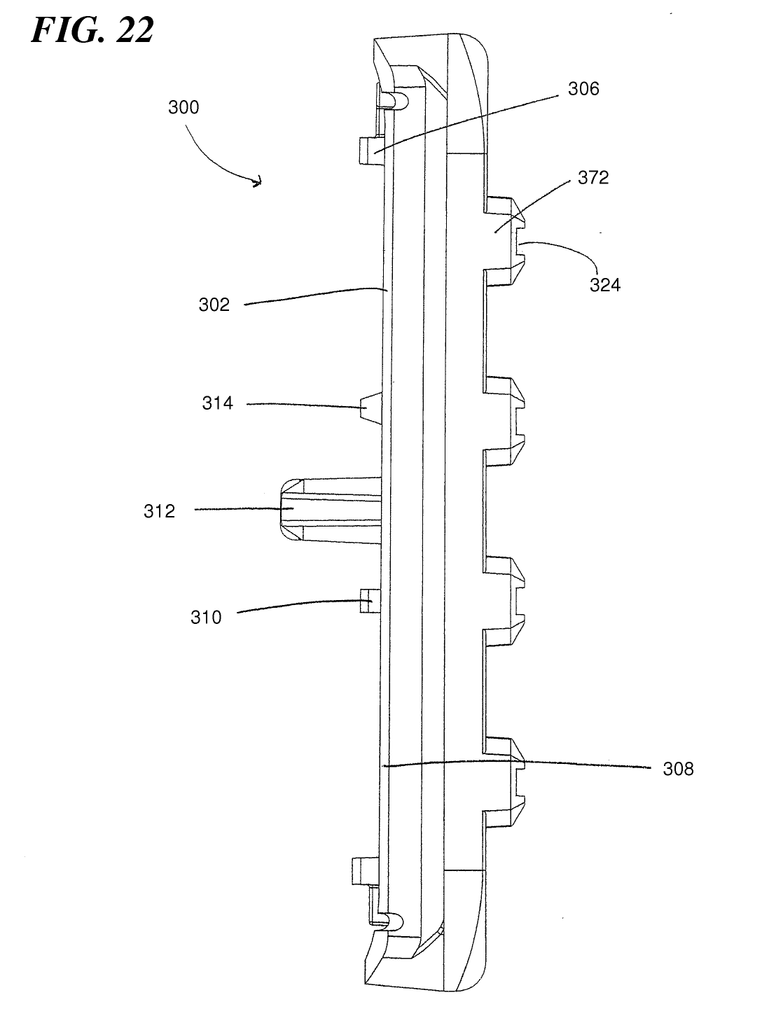

FIGS. 18-22 show a second embodiment of a housing portion 300 forming part of an emitter and embodying features of the present invention. Like the first embodiment, this housing portion 300 includes a boundary wall 302 extending from the base 304. As can be seen from FIGS. 13 and 18, the base 204 or 304 need not be a planar surface.

The boundary wall 302 is composed of two curved end walls 306 and two side walls 308 with a partition 310 between the end walls 306. The partition 310 separates the outlet bath 34 into two sub-baths 318 and 320, thereby reducing the effective volume of the outlet bath 34. Again, this reduction increases the proximity and effectiveness of the copper member 64 with respect to roots potentially intruding into the outlet bath 34. However, this preferred form is generally designed for use with another type of emitter—an emitter without a check valve. One form of such an emitter is shown and described in U.S. application Ser. No. 11/394,755, which has been assigned to the applicant and is incorporated by reference herein in its entirety.

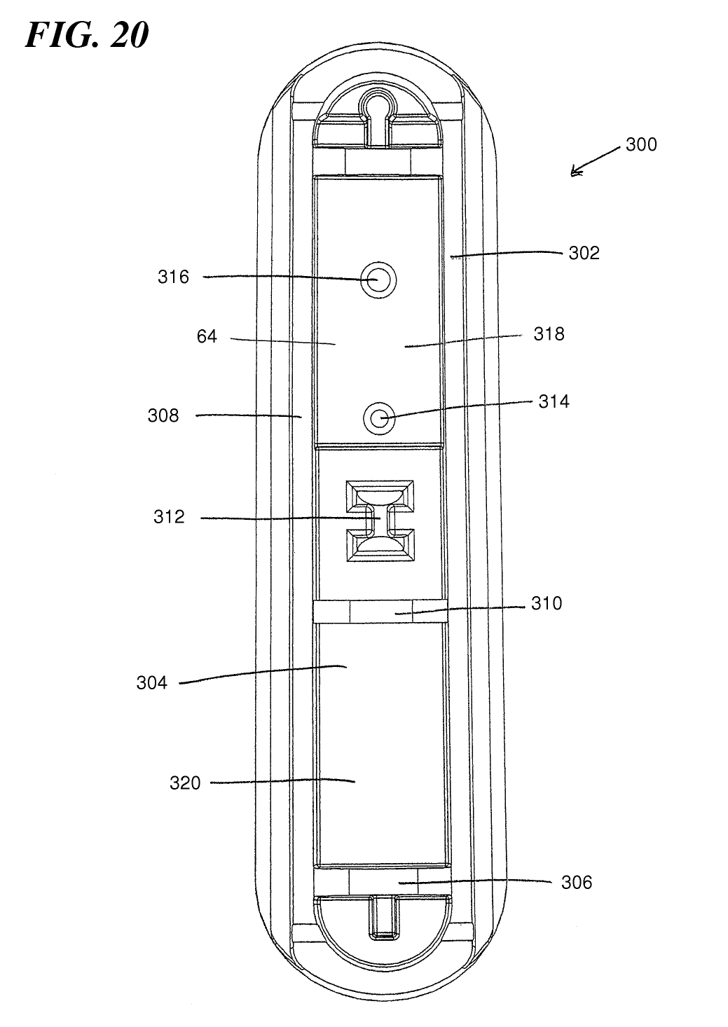

As shown in FIGS. 18 and 20, the exterior side of the housing portion 300 is generally similar to that of the first embodiment described above. Again, the exterior side preferably includes the two end walls 306, the two side walls 308, the partition 310, a chimney or post 312, a locator post 314 for mounting a copper member 64, and the emitter outlet 316. As can be seen, the two end walls 306 preferably have a curvature corresponding generally to that of the supply tube 100. The chimney 312 has generally the same shape and preferably is formed in the same manner as those described above. The partition 310 is also similar in structure to that described above and serves the same purpose of acting as a physical barrier to discourage the infiltration and accumulation of plant roots and other materials in the far end (“dead zone”) of the outlet bath 34 (away from the copper member 64) to prevent long term deterioration of the emitter.

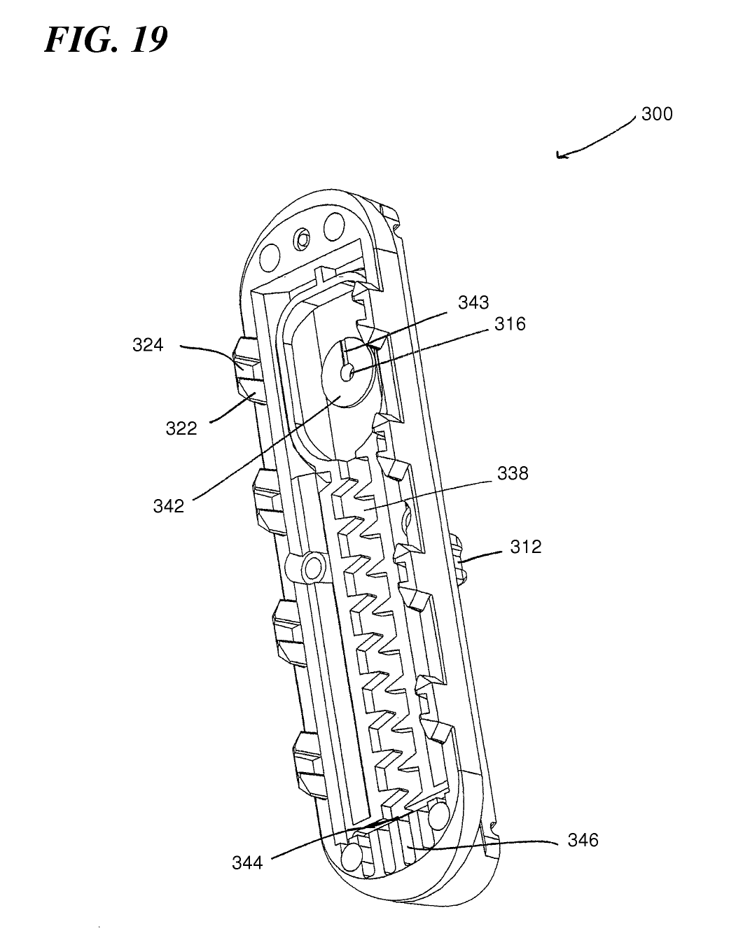

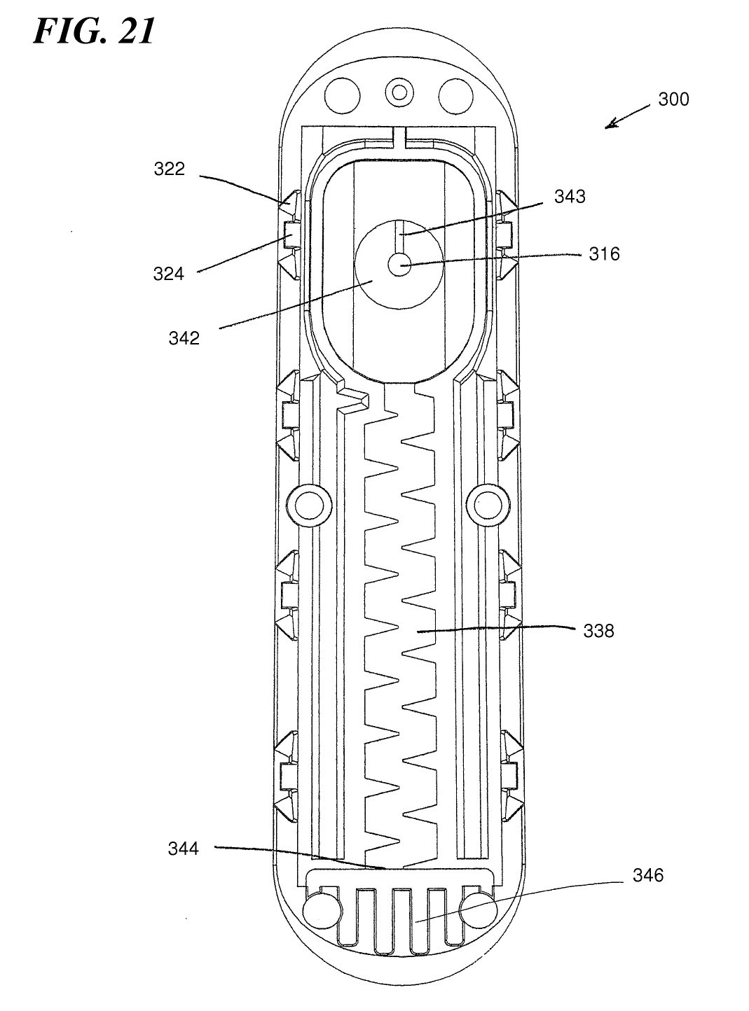

As shown in FIGS. 19 and 21, the interior side of the housing portion 300 has some similarities and some differences from those described above. Again, it includes an inlet end 344, a pressure-reducing flow channel 338, and a water metering surface 342 with a groove 343 formed therein. The inlet end 344 is defined generally by a plurality of slots 346 at one end that allow water to flow underneath an overlaying diaphragm 36. Water enters the inlet end 344, flows through the tortuous path flow channel 338, and flows past the water metering surface 342 to the emitter outlet 316. In this form, the interior side also preferably includes posts 322 extending upwardly from the outside of the housing portion 300 and acting as engagement members to fasten housing portion 300 to a second housing portion. The second housing portion preferably has corresponding tabs that slide into the recesses 324 of the posts 322. In this form, the posts 322 and corresponding tabs help align the two housing pieces with respect to one another.

As should be evident, the housing portions described herein can be used in conjunction with many different types of emitters. The housing portions generally include two end walls, two side walls, and a partition that (in conjunction with a supply tube) form a well-defined outlet bath that is generally protected from plant root intrusion. Further, the partition divides the outlet bath into two sub-baths and thereby generally reduces the volume of the outlet bath available to plant roots seeking to intrude through the supply tube outlet. In addition, the outlet bath volume accessible through the supply tube outlet is in close proximity to the copper member, thereby increasing the effectiveness of the copper member and extending the life of the emitter. As should be evident, the shape and structure of the partitions may be modified while achieving the same effect, and the housing portion itself can be modified to include different structure or structure in addition to the partitions.

The preferred material for the member 64 consists of entirely, or almost entirely, copper. Copper alloy, including alloy containing 50% or more copper, may also be used to inhibit root intrusion. Alternatively, the member 64 may include non-copper and copper potions, such as a plastic core surrounded completely or in part by an outer copper layer. Further, as should be evident, the geometry, dimensions, and arrangement of such copper members 64 may vary depending on the specific shape and size of the subsurface drip emitter and its outlet and is not limited to the geometry of the embodiments shown in FIGS. 2-5 and 11.

One significant advantage of the copper member 64 is that the emitter outlets 22 are easily locatable. Subsurface drip emitters, made of plastic, silicone, and rubber components, and buried underground, are generally not readily locatable from above ground. By using copper at the emitter outlet 22 of each emitter 10, a metal detector can be used to easily locate the exact position of emitter outlets 22 in the drip irrigation tube 100 despite the fact that the tube 100 and emitters 10 are buried.

Moreover, copper installed in each emitter 10 can be located with a metal detector so that irrigation tubes 100 and emitters 10 can be easily located years after the system is installed. For example, this feature helps easily locate irrigation tubes 100 underground to prevent tube puncture that may result from the installation of aeration equipment, tent stakes, signs, etc. This feature also helps easily locate irrigation tubes 100 and emitters 10 underground to accomplish maintenance practices on the tubes 100 and emitters 10, such as replacing pieces of tubing, changing the layout of the irrigation system, and replacing old emitters with new emitters having different flow rates.

An additional advantage provided by the copper member 64 is that the protection against intruding plant roots is not affected by non-level terrain or relative orientation of the drip emitter 10. Chemicals used to prevent intruding roots may run off or otherwise become distributed unevenly where the terrain is not level or where the emitter 10 is oriented in a certain manner. In contrast, the emitter outlet 22 is protected by the copper member 64, which is affixed directly thereto, and such protection is not affected by the unevenness of the terrain or the orientation of the emitter 10.

Another significant advantage provided by the copper member 64 is that it does not seriously harm plants or detrimentally impact the environment. The copper taken up by a plant root has a localized effect on the root and does not harm the entire plant. Further, the above embodiments do not rely on the use of an herbicide to protect against plant root intrusion, which may have a significant and detrimental plant and environmental impact. Instead, the above embodiments prevent root intrusion in an environmentally friendly manner.

Another advantage provided by the copper member 64 is that it does not require user intervention to inhibit root growth. Solutions that use chemical treatments often require the chemical to be added to the irrigation system seasonally. User training is required to ensure the user understands that chemicals are required, and the user must remember to reapply the chemicals at regular intervals. The copper member 64 avoids these problems because it is built-in to the product.

The foregoing relates to preferred exemplary embodiments of the invention. It is understood that other embodiments and variants are possible which lie within the spirit and scope of the invention as set forth in the following claims.

What is claimed is:

1. A drip emitter comprising:
a body for mounting to an inner surface of a supply tube;
an inlet defined by the body and capable of receiving pressurized fluid from the supply tube;
a flow path from the inlet to an outlet formed in the emitter;
a pressure reducing flow channel located in the flow path;
a metal structure disposed at the body and including at least copper metal;
wherein the body includes a base and a boundary wall extending from the base, the boundary wall defining an outlet bath between the base and the inside surface of the supply tube when the body is mounted to the inner surface; and
wherein the body includes a partition extending from the base and dividing the outlet bath into a first sub-bath and a second sub-bath.

2. The drip emitter of claim 1 further comprising a post extending from the base, the post defining at least in part a supply tube outlet when the emitter body is mounted to the inner surface of the supply tube.

3. The drip emitter of claim 2 wherein the first sub-bath includes a flow path between the emitter outlet and the supply tube outlet and the second sub-bath does not includes this flow path.

4. The drip emitter of claim 3 wherein the metal structure is attached to the body within the first sub-bath.

5. The drip emitter of claim 4 wherein the boundary wall has a curvature corresponding to the curvature of the supply tube.

6. The drip emitter of claim 5 wherein the boundary wall comprises two end walls and two side walls.

7. The drip emitter of claim 6 wherein each of the first and second sub-baths is defined in part by one end wall, the partition, and portions of the two side walls.

8. The drip emitter of claim 7 wherein the height of the partition is the same as or less than the height of the end walls, the height being the distance the partition and the end walls extend from the base.

9. The drip emitter of claim 1 wherein the metal structure is in the form of a plate with a copper outer surface.

10. The drip emitter of claim 9 wherein the metal structure defines a first hole and a second hole therethrough and wherein the body of the emitter has a locator post extending outwardly therefrom, the first hole extending over the emitter outlet when the second hole receives the locator post.

11. The drip emitter of claim 1 further comprising a valve at or near the inlet.

12. An irrigation system comprising:
a supply tube having an interior through which fluid is supplied and having a wall with a plurality of supply tube outlets extending therethrough;
a plurality of drip emitters mounted to the wall within the interior of the supply tube, at least one drip emitter comprising:
a body for mounting to an inner surface of the supply tube;
an inlet defined by the body and capable of receiving pressurized fluid from the supply tube;
a flow path from the inlet to an outlet formed in the emitter;
a pressure reducing flow channel located in the flow path;
a metal structure attached to the body including at least copper metal;
wherein the body includes a base and a boundary wall extending from the base, the wall defining an outlet bath between the base and the inside surface of the supply tube when the body is mounted to the inner surface; and
wherein the body includes a partition extending from the base and dividing the outlet bath into a first sub-bath and a second sub-bath.

13. The irrigation system of claim 12 wherein the at least one drip emitter further comprises a post extending from the base, the post defining at least in part a supply tube outlet when the emitter body is mounted to the inner surface of the supply tube.

14. The irrigation system of claim 13 wherein the first sub-bath includes a flow path between the emitter outlet and the supply tube outlet and the second sub-bath does not includes this flow path.

15. The irrigation system of claim 14 wherein the metal structure is attached to the body within the first sub-bath.

16. The irrigation system of claim 15 wherein the height of the partition is the same as or less than the height of at least a portion of the boundary wall, the height being the distance the partition and boundary wall extend from the base.

17. The irrigation system of claim 12 wherein the metal structure is in the form of a plate with a copper outer surface.

18. The irrigation system of claim 17 wherein the metal structure defines a first hole and a second hole therethrough and wherein the body of the emitter has a locator post extending outwardly therefrom, the first hole extending over the emitter outlet when the second hole receives the locator post.
